(19) United States
(12) Patent Application Publication
(10) Pub. No.: US 2020/0223467 A1
(43) Pub. Date: Jul. 16, 2020

(54) Push Handle Unit

(71) Applicant: Technibilt, Ltd., Newton, NC (US)

(72) Inventors: Nina Olbrich, Weidenstetten (DE); Thomas Gasche, Leipheim (DE); Johann Daminger, Neu-Ulm (DE); Gerhard Müller, Jettingen-Scheppach (DE); Paul Ruf, Eppishausen (DE)

(73) Assignee: Technibilt, Ltd., Newton, NC (US)

(21) Appl. No.: 16/742,362

(22) Filed: Jan. 14, 2020

(30) Foreign Application Priority Data
Jan. 14, 2019 (DE) 102019100753.4

(51) Int. Cl. B62B 3/14; B62B 5/06

(52) U.S. Cl. CPC B62B 3/1472; B62B 2202/023; B62B 5/06

(57) ABSTRACT

The invention relates to a push handle unit (20, 20′), comprising at least one first and at least one second end piece (30), and further comprising at least one fastening device for fastening the respective end piece (30) to a transport cart, wherein the first and second end pieces (30) are connected by way of a cross brace (50), wherein the cross brace (50) comprises a middle part (60, 60′), and wherein the middle part (60, 60) comprises a display unit (620), wherein the middle part (60) furthermore includes cut-outs (630) and/or recesses (640) to partially or completely accommodate functional elements (70) and/or objects (80), and wherein the functional elements (70) are inserted into the cut-outs (630) and/or recesses (640) in an exchangeable and/or stationary manner, wherein the cut-outs (630) and/or recesses (640) are furthermore arranged next to one another.

The present invention relates to a push handle unit for a manually movable transport cart and to a transport cart comprising such a push handle unit.

Manually movable transport carts are known from self-service markets. They comprise a push handle unit to simplify the pushing of the cart.

A push handle unit that is arranged on a transport cart is described in DE 10 2017 104 407 B4, for example. The push handle unit comprises two end pieces, a cross brace and a middle part. The push handle unit is arranged on a manually movable transport cart by means of a fastening device. Self-supporting, upwardly projecting grip units are provided. These are formed of a grip unit receptacle and a grip unit insert, wherein the grip unit insert can include an object holder, for example for a beverage cup or a scanner.

A push handle unit is furthermore known from EP 2 888 148 B1. On this unit, a receptacle for a cup or an object having a radial cross-section and a smartphone is provided in the middle part. The receptacle for the radial object is implemented in the left region of the middle part. In contrast, the receptacle for the smartphone is arranged in the front right region of the middle part, which faces the person pushing the shopping cart. Moreover, a coin deposit lock is provided above the receptacle for the smartphone.

The different chains of stores have different desires with respect to a use of functional elements, such as additional holders, hook parts and the like, and these desires can change over time. A push handle unit comprising self-supporting, upwardly projecting grip units is associated with higher costs than conventional handle caps, so that the use thereof is not always an option.

Against this background, it is an object of the present invention to provide a cost-effective push handle unit, which allows additional functional elements to be used flexibly as needed by way of a variable arrangement.

According to one aspect of the present invention, this object is achieved by a push handle unit, comprising at least one first end piece and at least one second end piece, and further comprising at least one fastening device for fastening the respective end piece to a transport cart, wherein the first and second end pieces are connected by way of a cross brace, wherein the cross brace comprises a middle part, and wherein the middle part comprises a display unit, wherein the middle part furthermore includes cut-outs and/or recesses to partially or completely accommodate functional elements and/or objects, and wherein the functional elements are inserted into the cut-outs and/or recesses in an exchangeable and/or stationary manner, wherein the cut-outs and/or recesses are furthermore arranged next to one another.

By arranging the cut-outs and/or recesses next to one another or in a row, it is possible to insert functional elements and/or objects as needed. If necessary, a replacement or an exchange is easily possible.

According to another aspect of the present invention, this object is furthermore achieved by a transport cart comprising such a push handle unit.

One concept of the present invention is thus to provide cut-outs and/or recesses and to equip these, as needed, with functional elements.

In a preferred embodiment, the push handle unit comprises functional elements that are designed, for example, as a holder, a hook part or as what is known as a dummy insert.

Depending on requirement, the functional elements can be easily inserted into the previously provided cut-outs and/or recesses. If no functional part is to be inserted, and the cut-outs and/or recesses are not to be utilized to accommodate objects, the cut-outs and/or recesses can be covered for safety reasons, by using the dummy insert. In this way, potential vandalism can be prevented.

In a preferred embodiment, the cut-outs and/or recesses furthermore have a substantially rectangular, square or round cross-section.

The arrangement of the cut-outs and/or recesses on the middle part can thus be planned in a space-saving manner.

Particularly preferably, the cut-outs and/or recesses are provided in the rear region of the middle part.

The rear region of the middle part is the region located further away from the person pushing the cart. The middle part is designed accordingly large and offers sufficient space therefor, in addition to the display unit.

In another embodiment, two or four cut-outs and/or recesses are preferably provided.

Two slightly larger cut-outs and/or recesses offer sufficient space to accommodate a smartphone.

If four cut-outs and/or recesses are used, additional functional elements can be inserted next to one another, without these impeding one another or interfering with the use of the transport cart.

The use of two or four cut-outs and/or recesses proves, in particular, to be advantageous since the middle part still has sufficient stability, and the size of the cut-outs and/or recesses can be kept comparatively small.

In another embodiment, the cross brace of the push handle unit is implemented as an oval tube.

The use of an oval tube has proven to be advantageous due to the improved absorption and/or distribution of forces.

In another embodiment, the push handle unit furthermore comprises a coin deposit system.

The coin deposit system can be easily integrated into the middle part in a space-saving manner. Sufficient room is provided therefor beneath the display unit.

In another preferred embodiment, the push handle unit is made of at least one injection moldable plastic material.

In this embodiment, the push handle unit can be produced cost-effectively in high quantities.

The push handle unit is particularly preferably at least partially produced by way of a two-component injection molding process.

In this embodiment, special haptic properties can be created, and the weather conditions can be counteracted better, as needed, to ensure long durability.

The above characteristics and those explained below can, of course, be used not only in the described combination, but also in other combinations or alone, without departing from the scope of the present invention.

Exemplary embodiments of the invention are shown in the drawing and will be described in greater detail in the following description. In the drawings:

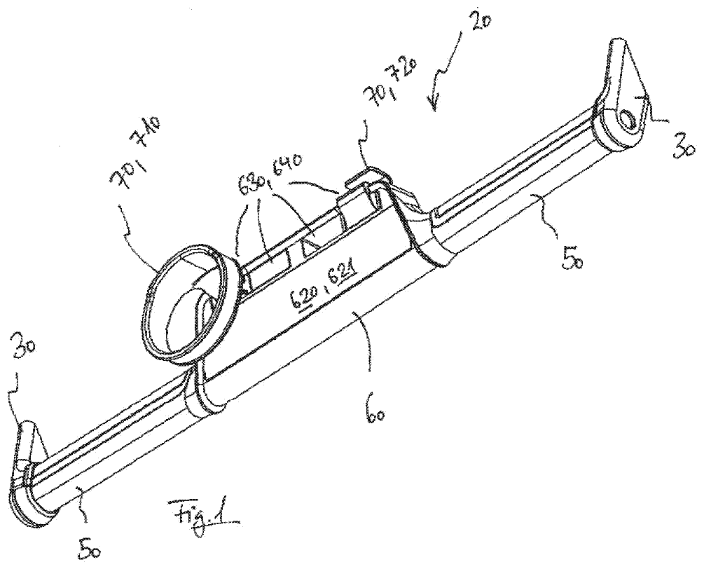

FIG. 1 shows a push handle unit in a perspective view, comprising end pieces, a cross brace and a middle part, which includes a display unit and four cut-outs/recesses for accommodating functional elements;

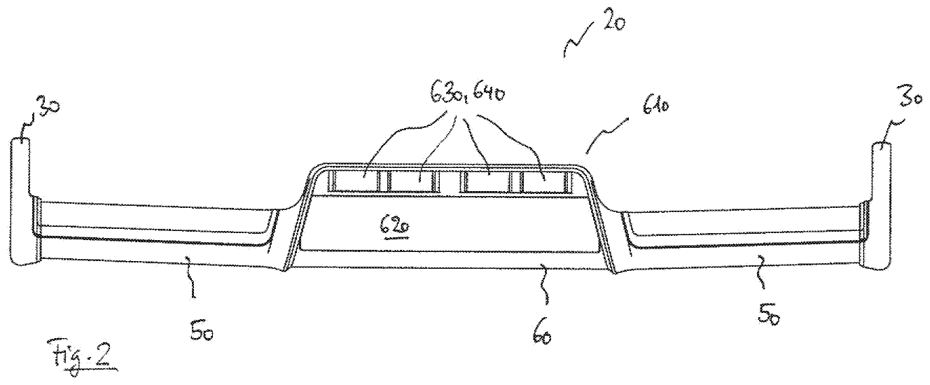

FIG. 2 shows the same push handle unit without functional elements in a top view;

FIG. 3 shows another embodiment of a push handle unit in a perspective view, including two cut-outs/recesses for accommodating at least one object (smartphone);

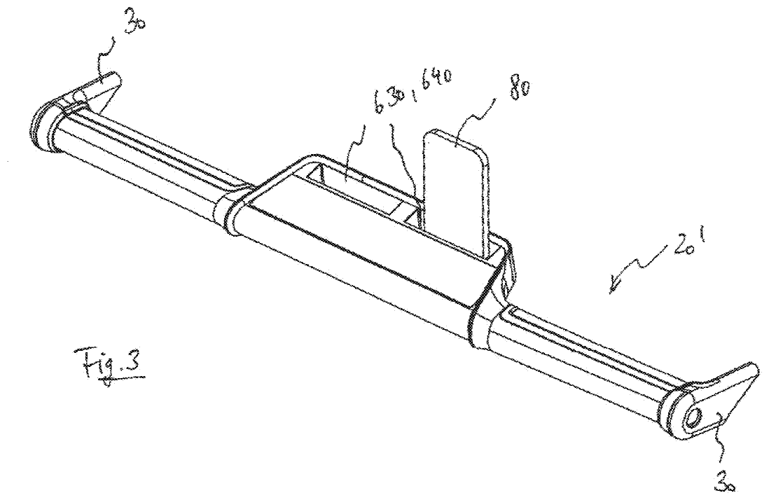

FIG. 4 shows the preceding embodiment of the push handle unit in a perspective view, without a cover and without end pieces;

FIG. 5 shows the preceding embodiment of the push handle unit in a perspective view, with a cover to be inserted;

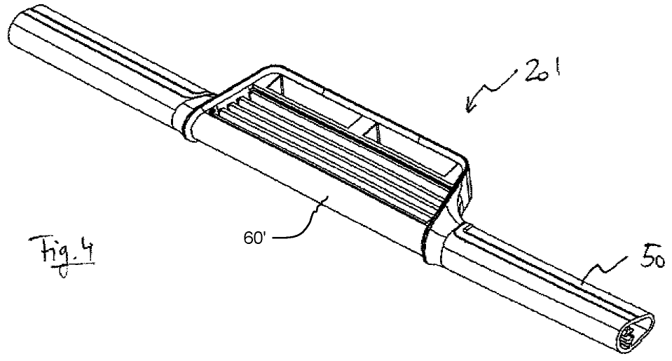

FIG. 6 again shows the preceding embodiment of the push handle unit in a side view, with a cover to be inserted;

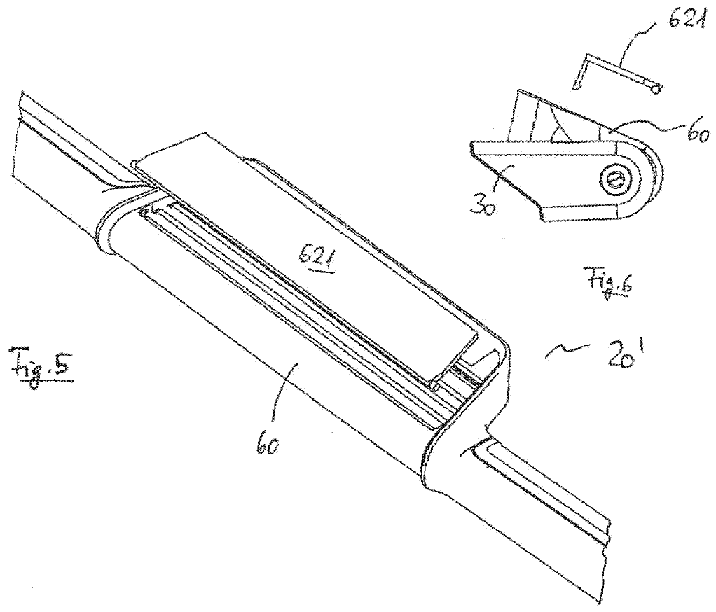

FIG. 7A shows a functional element in the form a hook part in a perspective view;

FIG. 7B shows the same hook part in a side view;

FIG. 8A shows a functional element in the form a holder in a perspective view;

FIG. 8B shows the same holder in a side view;

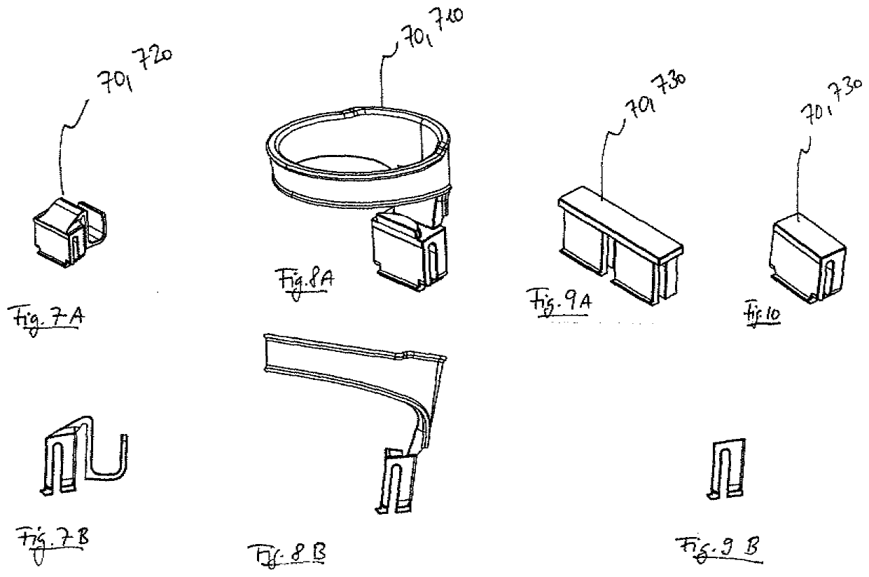

FIG. 9A shows a functional element in the form of a dummy insert in a perspective view, to be inserted into two cut-outs/recesses;

FIG. 9B shows a functional element in the form of a dummy insert in a side view, to be inserted into a cut-out/recess; and

FIG. 10 shows both variants of a blind insert in a perspective view.

FIG. 1 shows an exemplary embodiment of a push handle unit 20. This comprises two end pieces 30. A cross brace 50 including a middle part 60 is provided. The middle part 60 includes a display unit 620 and cut-outs 630 and/or recesses 640 for accommodating functional elements 70.

Two identical end pieces 30 are provided, which are used for the arrangement on a basket of a transport cart, such as a shopping cart. A respective fastening device is used to securely and permanently arrange the push handle unit 20 on the basket by means of the end pieces 30. Other end pieces are also conceivable, which depend on the design of the basket or base frame of the transport cart.

Four cut-outs 630 and/or recesses 640 are provided, which are arranged next to one another and in a row. A different number of cut-outs 630 and/or recesses 640, such as three or five, is conceivable.

The cross-sections of the cut-outs 630 and/or recesses 640 are all identical in size and rectangular. In this way, it is easily possible to exchange the functional elements 70. Square and also round or oval cross-section are conceivable. In an alternative embodiment, the cross-sections have different designs and are combined as needed.

It has proven useful to preferably provide the cut-outs 630 and/or recesses 640 in the rear region 610 of the middle part 60.

A hook part 720 is inserted in the row on the far right by way of example. This is shown again as FIGS. 7A, B. The hook of the hook part 720 is outwardly directed and is thus easy to use. The hook surface is preferably implemented across the entire width of the hook part 720.

A holder 710 is arranged on the far left in the row of cut-outs 630 and/or recesses 640. This is shown again as FIGS. 8A, B. It is used to accommodate a beverage container, for example, or alternatively a hand-held scanner. The radial receptacle is oriented toward the person navigating the cart and is delimited by the size of the radius to the depth of the middle part. For the most part, a protrusion would not be very desirable. In an alternative embodiment, the radial receptacle, as well as the hook part 720, can be outwardly directed.

In another alternative embodiment, the cut-outs and/or recesses have a square or round cross-section.

The display unit 620 is implemented flush with the surface of the middle part 60. It has proven advantageous to additionally provide a raised border on the middle part 60.

Dummy inserts 730 can be inserted, for example, into the two middle cut-outs 630 and/or recesses 640, as they are illustrated in FIG. 9A, 9B or 10.

FIG. 2 shows the same push handle unit 20 without functional elements in a top view. Four rectangular cut-outs 630 and/or recesses 640 are provided. Depending on requirement, these are implemented as cut-outs 630 and/or recesses 640.

A land is provided between the cut-outs 630 and/or recesses 640. This can be implemented in different widths. If four cut-outs 630 and/or recesses 640 are provided, it has proven useful to provide two cut-outs 630 and/or recesses 640 on the right and two on the left, and to separate these from one another by a wider land.

FIG. 3 shows another embodiment of a push handle unit 20′ in a perspective view. This is implemented with two cut-outs 630 and/or recesses 640 to accommodate at least one object 80, here in the form of a smartphone. It has proven useful to provide at least one recess 640 to accommodate at least one object 80.

The size of the opening of the recesses 640 depends on the size of the customary smartphone. The recesses 640 are designed such that the smartphone is stored securely. Another arbitrary object, which is not illustrated in detail, or other functional elements can be arranged in the adjoining cut-out 630 and/or recess 640 arranged in the row.

FIG. 4 shows the preceding embodiment of the push handle unit 20′ including two cut-outs 630 and/or recesses 640 in a perspective view, without a cover and without end pieces. Four horizontally extended braces are provided in the interior of the middle part 60′. These impart stability to the push handle unit 20, 20′. As an alternative, the interior of the middle part 60′ could be configured with a coin deposit system. The middle part 60 can have an identical composition.

FIG. 5 shows the preceding embodiment of the push handle unit 20′ in a perspective view, with a cover 621 to be inserted. Two cylindrical pins are provided for the accommodation of the cover 621 in the middle part 60′. These engage in the interior of the middle part 60′. In this way, a pivoting motion of the cover 621 can be possible, which enables a simple replacement of an advertisement insert, for example. Moreover, the cover 621 preferably has a right-angled termination. In this way, contamination of the display unit 620, for example of an advertisement insert, can be prevented. However, other types of display units are also conceivable. These can also have an appropriate electronic design.

FIG. 6 again shows the preceding embodiment of the push handle unit 20′ in a side view, with a cover 621 to be inserted. The cover 621 is not intended to cover the entire middle part 60′, but only the region in which the display unit 620 is provided. The side view of the push handle unit 20′ also again illustrates the right-angled termination of the cover 621. It is also possible to arrange the cover 621 on the middle part 60.

FIGS. 7A and 7B show a functional element 70 in the form a hook part 720. The representation illustrates a U-shaped hook, an obliquely extending head part, and a releasable clip connection, which can also be designed as a wedge lock. By pushing the two wall halves together, it is possible to easily bring the hook part 720 into one of the cut-outs 630 and/or recesses 640 and also to easily remove it again, such as in the event of a defect. Moreover, the border around the middle part 60 is used to accommodate the hook part 720 in a secure manner. A distance is provided between the actual hook and the clip connection, which is preferably used to place the hook part 720 in a secure manner onto the border around the middle part 60, 60′.

FIGS. 8A, 8B show a functional element 70 in the form of a holder 710.

This is preferably used to accommodate a beverage cup. For this purpose, it includes a radial receptacle.

FIGS. 9A, B and 10 show a functional element 70 in the form of a dummy insert 730 for introducing one or two cut-outs 630 and/or recesses 640 of the middle part 60, 60′. Such a dummy insert 730 is used to cover the cut-outs 630 and/or recesses 640 and is introduced flush with the surface of the middle part 60, 60′ to the greatest extent possible.

The push handle unit 20, 20′ is made of an injection moldable plastic material. Moreover, it has proven advantageous to produce the push handle unit 20, 20′ at least partially by way of a two-component injection molding process.

### LIST OF REFERENCE NUMERALS

20, 20′ push handle unit
30 end piece
50 cross brace
60, 60′ middle part
610 rear region
620 display unit
621 cover
630 cut-outs
640 recesses
70 functional element
710 holder
720 hook part
730 dummy insert
80 object

1.-10. (canceled)

11. A push handle unit, comprising:
a first end piece and a second end piece; and
a cross brace interposed between, and connected to, the first and second end pieces, the cross brace comprising a middle part;
the middle part comprising a display unit and a plurality of accommodation elements;
an accommodation element of the plurality of accommodation elements:
(i) being arranged next to another accommodation element of the plurality of accommodation elements,
(ii) comprising either a cut-out or a recess, and
(iii) at least partially accommodating either a functional element or an object.

12. The push handle unit of claim 11, wherein the functional element comprises a holder.

13. The push handle unit of claim 11, wherein the functional element comprises a hook part.

14. The push handle unit of claim 13, wherein the hook part comprises a U-shaped hook, an obliquely extending head part, and a releasable clip connection.

15. The push handle unit of claim 11, wherein the functional element comprises a dummy insert.

16. The push handle unit of claim 11, wherein an accommodation element of the plurality of accommodation elements has a substantially rectangular cross-section.

17. The push handle unit of claim 11, wherein an accommodation element of the plurality of accommodation elements has a substantially square cross-section.

18. The push handle unit of claim 11, wherein an accommodation element of the plurality of accommodation elements a substantially round cross-section.

19. The push handle unit of claim 11, wherein, an accommodation element of the plurality of accommodation elements is in a rear region of the middle part.

20. The push handle unit of claim 11, wherein there are two accommodation elements.

21. The push handle unit of claim 11, wherein there are four accommodation elements.

22. The push handle unit of claim 11, wherein the cross brace comprises an oval tube.

23. The push handle unit of claim 11, and further comprising a coin deposit system.

24. The push handle unit of claim 11, wherein at least one accommodation element of the plurality of accommodation elements is configured to accommodate a smartphone.

25. The push handle unit of claim 11, wherein all accommodation elements are of a single shape.

26. The push handle unit of claim 11, wherein all accommodation elements are of a single size.

27. The push handle unit of claim 11, and further comprising a rotatable cover, the rotatable cover covering at least a portion of the middle part when the rotatable cover is in a closed position.

28. The push handle unit of claim 11, wherein the middle part further comprises a plurality of horizontal braces.

29. The push handle unit of claim 11 wherein at least one of the first and second end pieces, the cross brace, or the middle part comprises an injection moldable plastic material.

30. The push handle unit of claim 11 wherein at least one of the first and second end pieces, the cross brace, or the middle part comprises a two-component injection molding product.
